(19) United States
(12) Patent Application Publication
(10) Pub. No.: US 2013/0047116 A1
(43) Pub. Date: Feb. 21, 2013

(54) System of Project Management and Analysis by Standardization of Project Components and Methods Thereof

(71) Applicant: Evan Dudik, Vancouver, WA (US)

(72) Inventor: Evan Dudik, Vancouver, WA (US)

(21) Appl. No.: 13/586,862

(22) Filed: Aug. 15, 2012

Related U.S. Application Data
(60) Provisional application No. 61/523,813, filed on Aug. 15, 2011.

(51) Int. Cl. G06F 3/048

(52) U.S. Cl. 715/781

(57) ABSTRACT

A computer-implemented method having presenting a user interface on a display device of a computer system, the user interface associated with a database, presenting a standardization window, receiving standardization information of a project, where the project is organized as a workstream, the workstream is organized as a plurality of initiatives, and the initiative is organized as a plurality of stages, where the stages are standardized allowing for each initiative to have the same stages, presenting an initiative window on the user interface, receiving initiative information, and displaying initiative information in the initiative window.

### CROSS-REFERENCE TO RELATED APPLICATION

This application claims the benefit of priority to U.S. Provisional Application No. 61/523,813 filed on Aug. 15, 2011, which is incorporated herein by reference in its entirety.

### BACKGROUND

Project management can be employed by corporations to ensure timely completion of product development, construction, or any plan requiring the utilization of multiple personnel and resources. Personnel with varying skill sets are selected for a project, a project leader is assigned, and the project leader establishes a schedule that details all of the required initiatives and milestones necessary for project completion. The project manager tracks the progress of the various initiatives and attempts to remedy situations that can cause the project to fail to meet a milestone.

In large companies, this structure is not possible, particularly where individuals assigned to a specific project are separated by large geographic space. In addition, standardization of projects is needed to ensure quality analysis of the status of initiatives.

### SUMMARY

The present disclosure pertains to a computer-implemented method having presenting a user interface on a display device of a computer system, the user interface associated with a database, presenting a standardization window, receiving standardization information of a project, where the project is organized as a workstream, the workstream is organized as a plurality of initiatives, and the initiative is organized as a plurality of stages, where the stages are standardized allowing for each initiative to have the same stages, presenting an initiative window on the user interface, receiving initiative information, and displaying initiative information in the initiative window, where the method is performed by one or more processors.

One aspect of the disclosure is a method where the stage is organized as a plurality of phases, where the phases are standardized allowing for each stage to have the same phases.

One aspect of the disclosure is a method having transmitting the initiative information to a server, storing the initiative information on a database as a record, retrieving the record from the database, and displaying the initiative information to the initiative window. One aspect of the disclosure is a method having altering initiative descriptions. One aspect of the disclosure is a method having approving stage completion. One aspect of the disclosure is a method having approving phase completion. One aspect of the disclosure is a method having calculating the weight savings attributed to an initiative and displaying the weight savings in the initiative window. One aspect of the disclosure is a method having presenting a report window, receiving report information, and displaying an initiative report in the initiative window. One aspect of the disclosure is a method having receiving roadblock information and displaying roadblock information in the initiative window. One aspect of the disclosure is a method having displaying a sub-initiative in the initiative window.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a pedigree chart of an initiative according to an exemplary embodiment.

FIG. 2 is a user interface of a system according to an exemplary embodiment.

FIG. 3 is a block diagram of a database according to an exemplary embodiment.

FIG. 4 is a user interface of a system according to an exemplary embodiment.

FIG. 5 is a user interface of a system according to an exemplary embodiment.

FIG. 6 is a user interface of a system according to an exemplary embodiment.

FIG. 7 is a block diagram of a computer system according to an exemplary embodiment.

FIG. 8 is a flow chart of a process according to an exemplary embodiment.

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

The following describes a system and methods of project management and analysis by standardization of workstreams, initiatives, stages, and/or phases of at least one project.

In one embodiment, the system can have at least one project organized by workstreams, initiatives, stages, phases, or any combination thereof. The project can be organized as at least one workstream, where a workstream is a component of the project. A workstream can be organized as at least one initiative, where an initiative is a component of the workstream. An initiative can be organized as a plurality of stages, where a stage is a step of the initiative. A stage can be organized as a plurality of phases, where a phase is a step of the stage.

In one embodiment, all initiatives are organized with the same stages thereby standardizing the organization of all initiatives of the project. In one embodiment, all stages are organized with the same phases, thereby standardizing the organization of the stages of the project. The standardization of the same stages and phases allows an administrator to obtain an accurate reporting of the status of the project, for example, assessing progress, meeting or missing of milestones, attaining monetary targets, or the like. The standardization of the same stages and phases allows the system to present a report window 310 of all initiatives demonstrating which stages or phase all initiatives are in at a moment in time. The standardization of the same stages and phases allows the system to present a report window 310 of all initiatives allowing for the stage or phase of one initiative to be compared to at least on other initiative. In one embodiment, the standardization of the stages and phases allows the components of the project to be weighted thereby allowing for projects, workstream, or initiatives to be compared to other projects, workstreams, or initiatives.

The system can be applied to a plurality of different types of projects in a plurality of fields. For example, service projects, including, without limitation, advertising and marketing projects, drug development, training and teaching curricula and syllabuses, medical process and procedure development, business planning, geopolitical/military operations planning, book or article writing, management of contracts, software development and testing, sales and marketing processes, mental and physical health evaluations and treatment, or the like; and goods projects, including, without limitation, design and implementation of manufacturing process for goods; replacement of obsolete goods, or the like. For illustration purposes, this disclosure will describe a cost reduction project.

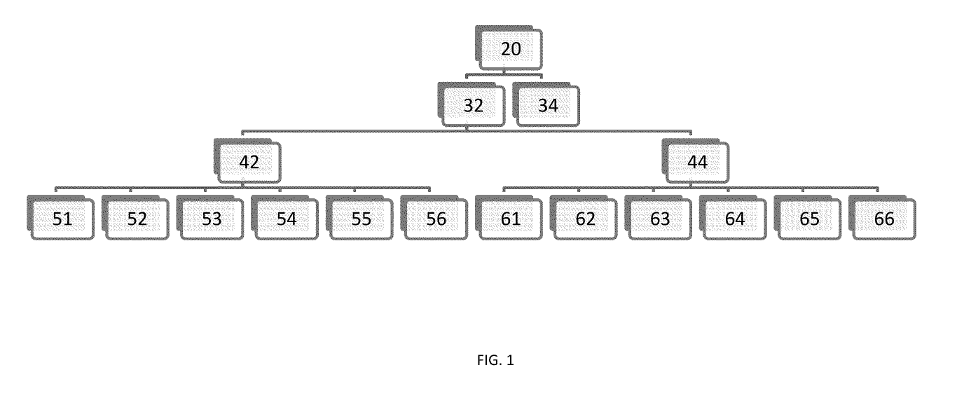

In one embodiment, the number of stages of an initiative can be determined by the administrator and can be dictated by the field to which the system is applied or factors specific to the managed project. As shown in FIG. 1, the cost reduction project 20 is organized as equipment replacement workstream 32 for replacing old energy inefficient equipment with new energy efficient equipment and position consolidation workstream 34 for consolidating roles or positions of employees. Equipment replacement workstream 32 is organized as fan replacement initiative 42 for replacing old fans with new, energy-efficient fans and refrigerator replacement initiative 44 for replacing old refrigerators with new, energy-efficient refrigerators. In this example, all initiatives, including fan replacement initiative 42 and refrigerator replacement initiative 44 of the workstreams 32, 34 are organized with the same stages. Specifically, fan replacement initiative 42 is organized as idea stage 51, written plan stage 52, approval stage 53, implementation stage 54, audit stage 55, and evaluation stage 56, and refrigerator replacement initiative 44 is organized as idea stage 61, written plan stage 62, approval stage 63, implementation stage 64, audit stage 65, and evaluation stage 66. While this example includes initiatives organized as the aforementioned six stages, the initiatives of the system can have any combination of these stages or additional stages.

In one embodiment, the number of phases of a stage can be determined by the administrator and can be dictated by the field to which the system is applied or factors specific to the managed project. In this example, all initiatives, including fan replacement initiative and refrigerator replacement initiative of the workstreams are organized with the same stages. Specifically implementation stage of the fan replacement initiative is organized as initiation phase, first implementation phase, second implementation phase, and completion phase, and implementation stage of refrigerator replacement initiative is organized as initiation phase, first implementation phase, second implementation phase, and completion phase. While this example includes the implementation stage of each initiative organized as the aforementioned four phases, the system can have any combination or order of these phases or additional phases.

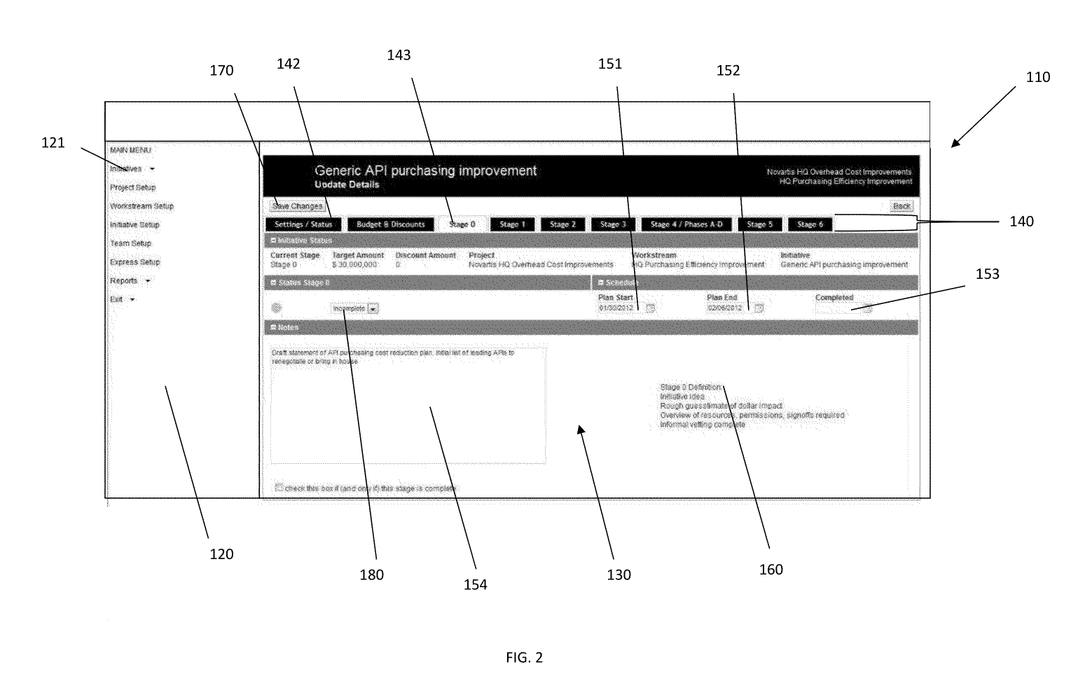

FIG. 2 shows an example user interface 110 for a database 200 application. The user interface 110 can provide a collection of user interface elements that give a user the tools needed to input, organize, query, browse, and/or view the content of a database 200. In one embodiment, the user interface elements, for example, drop-down menus, static menus, check boxes, buttons, tabs, input boxes, or the like, is associated with a project, workstream, initiative, stage, or phase and is representative of database 200s that can be accessed through the user interface 110. The user interface 110 can include a list control 120 that shows a collection of list items 121, for example, initiatives or reports, that can be representative of database 200s accessed through the user interface 110.

In one embodiment, the user interface 110 can include an initiative window 130. The initiative window 130 can provide a collection of initiative items 131 that give a user or vendor the tools needed to input, organize, query, browse, and/or view the content of a database 200. In one embodiment, the initiative window 130 has initiative items, for example, drop-down menus, static menus, check boxes, buttons, tabs, input boxes, or the like, where each initiative item is associated with a stage or phase of the initiative and is representative of database 200s that can be accessed through the initiative window 130.

The initiative window 130 can have a tab control 140 that presents a collection of initiative items (e.g. tabs), including overview tab 142, stage tabs 143, phase tabs, or any combination thereof, where each stage tab 143 is associated with a stage of the initiative and is representative of database 200s that can be accessed through the user interface 110, and each phase tab is associated with a phase of the initiative and is representative of database 200s that can be accessed through the user interface 110. For example, as shown in FIG. 2, the tab control 140 has an overview tab 142 represented by settings/status and stage tabs 143 including stage 0 representing idea stage tab, stage 1 representing written plan stage tab, stage 3 representing approval stage tab, stage 4 representing implementation stage tab, stage 5 representing audit stage tab, and stage 6 representing evaluation stage tab associated with the respective stages and database 200s.

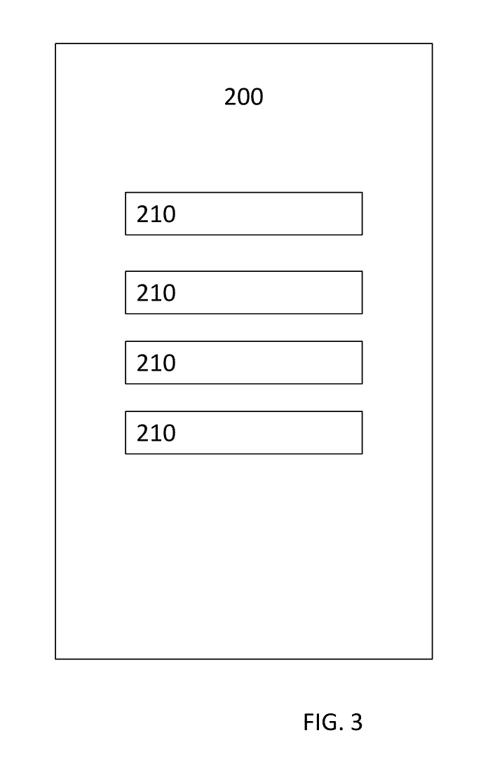

FIG. 3 is a block diagram of an example database 200. In some implementations, the database 200 can be an integrated collection of logically related records 210 or files consolidated into a common pool that provides data for one or more users. For example, the database 200 can be structured as a relational database, hierarchical database, a network database, an XML file, a text file, a delimited file (e.g., tab-delimited, CSV), or other type of collection of data.

In general, the database 200 can be structured as a collection of tables, wherein each table includes a collection of records 210 that represent a collection of related data, and the records 210 within a table can share a common collection of fields for storing datum. For example, a table can be structured to represent an initiative, a record 210 can be structured to represent a stage or phase, and a field can be structured to represent initiative information, for example, stage information or phase information. Stage information can include any information associated with the respective stage of the initiative, for example, stage information associated with the initiation stage can include, any information associated with the initiation of the initiative, for example, without limitation, the initiative idea, estimate of monetary savings, description of resources required, description of permissions required, description of signoffs required, whether the informal vetting has been complete, estimated stage completion date, or the like. Phase information can include, without limitation, any information associated with the respective phase, for example, phase information associated with the initiation phase of implementation stage can include any information associated with the initiation of the implementation of the initiative, for example, without limitation, description of parts ordered, description of services scheduled, whether a team leader has been assigned, whether all departmental signoffs are complete, estimated phase completion date, or the like.

The initiative window 130 can include initiative items in the form of input boxes 150 associated with at least one stage or phase. The initiative window 130 can include a plan start date box, a plan end date box, a completed date box, a stage information box, a phase information box, or any combination thereof. For example, as shown in FIG. 2, the initiative window 130 has a plan start date box 151, a plan end date box 152, a completed date box 153, and a stage information box 154. These input boxes can have corresponding record fields in the database 200.

The initiative window 130 can include a stage definition 160 where the initiative window 130 displays examples of the type of requested initiative information to be inputted into the respective stage information box or phase information box. For example, the stage definition 160 associated with the written plan stage can include, any examples requesting information associated with the written plan of the initiative, for example, without limitation, “written, complete initiative idea,” “formal contract with impacted parties,” “constituencies complete,” “objections met,” “projected implementation outline,” or the like.

The initiative window 130 can include a save changes button 170. When the save changes button 170 is activated by the user, the data input by the user is transmitted and stored to the database 200.

The initiative window 130 can include an approve/disapprove drop-down menu 180. In one embodiment, the approve/disapprove drop-down menu 180 is presented in the initiative window 130 of the administrator, thereby allowing for an administrator to approve or disapprove the completion of a respective stage or phase.

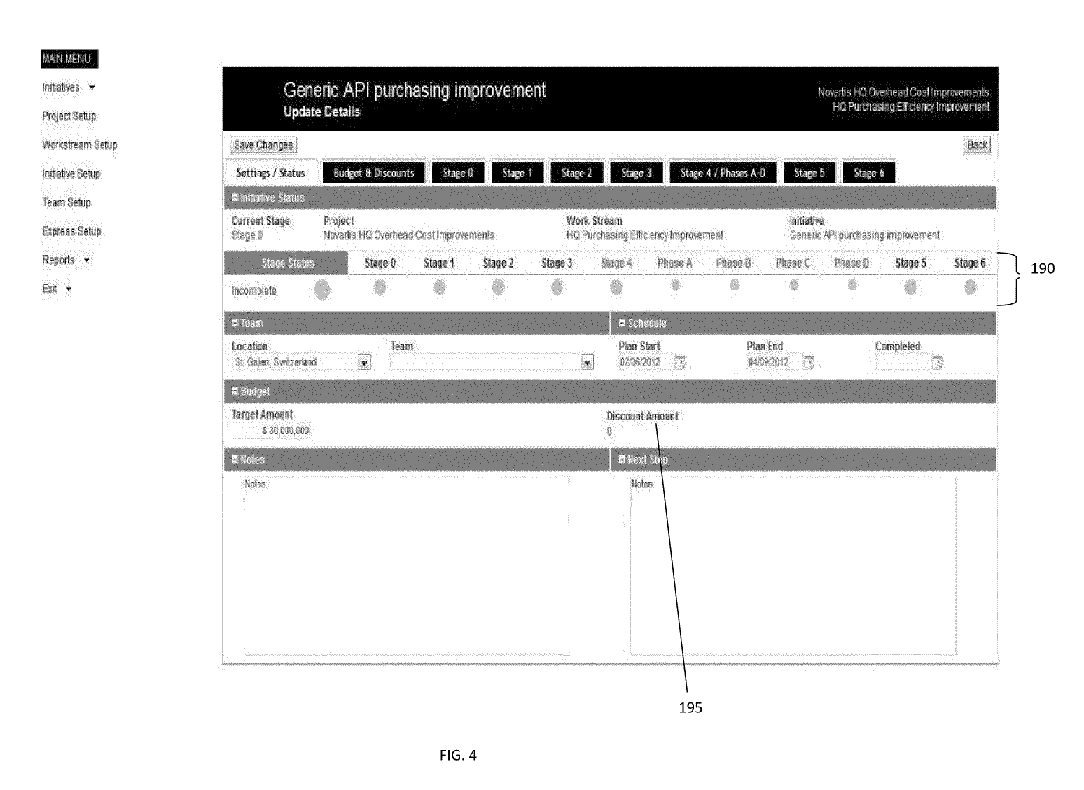

A status indicator 190 displays the status of an initiative by showing the stages and/or phases of the project that have been completed. For example, as shown in FIG. 4, the status indicator 190 can be a series of circles where one circle corresponds to a stage or phase. A blank circle indicates the stage or phase is incomplete and a filled circle indicates a stage or phase that has been completed.

An initiative weight indicator 195 represented as discount amount in FIG. 4, can display the amount of weight of an initiative as a component of a workstream or project. The initiative weight indicator 195 allows for a determination of target budget savings of all initiatives, workstreams, or projects at a specific point in time. This avoids over-estimating the value of incomplete initiatives and underestimating the value of complete or nearly-complete initiatives. The initiative weight indicator 195 allows for the initiatives to be compared and/or prioritized based on the amount of work required or number of remaining phases and/or stages remaining to complete the incomplete initiatives.

In one embodiment, the weight attributed to the initiative relates to the number of completed stages and/or phases of the initiative, the target budget savings of the initiative, or a combination thereof. For example, the initiative weight indicator 195 can be the product of the percentage of stages and/or phases of the total number of stages and phases, and the target budget savings of the initiative. For example, where the first two of the stages have been completed, the initiative has been assigned a completion percentage of 33% and the target budget savings of the project is $100,000, the initiative weight is 33% and the resulting weighted savings is $33,000.

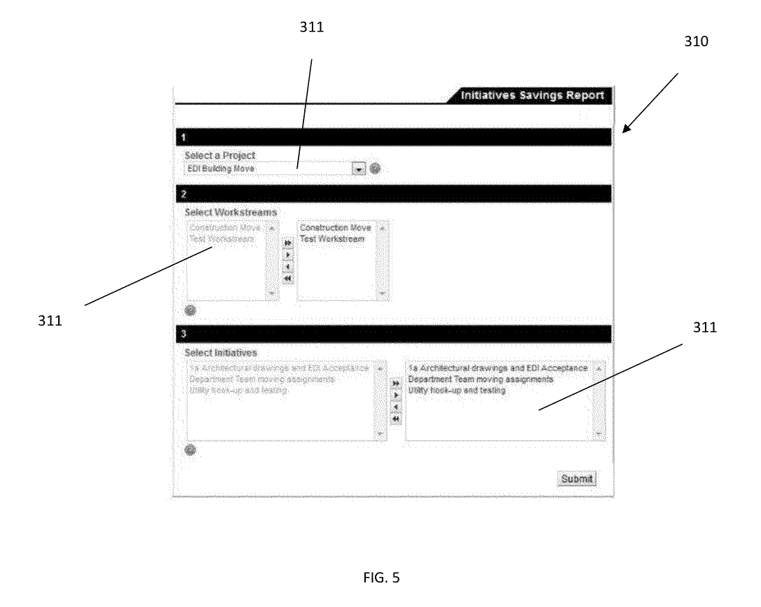

In one embodiment, as shown in FIG. 5, the user interface 110 can include a report window 310. The report window 310 can provide a collection of report elements 311 that give a user the tools needed to input, organize, query, browse, and/or view the content of a database 200. The report elements 311 can be drop-down menus, static menus, check boxes, buttons, tabs, input boxes, or the like for choosing or receiving the information to be displayed in the report window 310. The report elements 311 can have corresponding record fields in the database 200.

The report window 310 can display report information associated with the initiative weight, weighted savings, budget, calendar/time-line, stage and/or phase completion status, comparison of current weighted savings with any prior period, requirements to approve stage or phase completion, project, workstream, and/or initiative completion status, and notification element for notifying when an initiative, stage or phase, is about to miss a completion deadline. The report window 310 can display the status of all or a portion of initiatives at a moment in time and allows for a comparison of all initiatives by comparing the stage or phase of each initiative at a moment in time. The initiatives can be compared and/or prioritized based on the amount of work required for completion of the initiative, the number of stages or phases completed, the number of remaining stages or phases to be completed, and/or the weighted savings associated with each initiative. In one embodiment, the report information displayed in the report window 310 can be transmitted as an electronic document or printed as a hard copy.

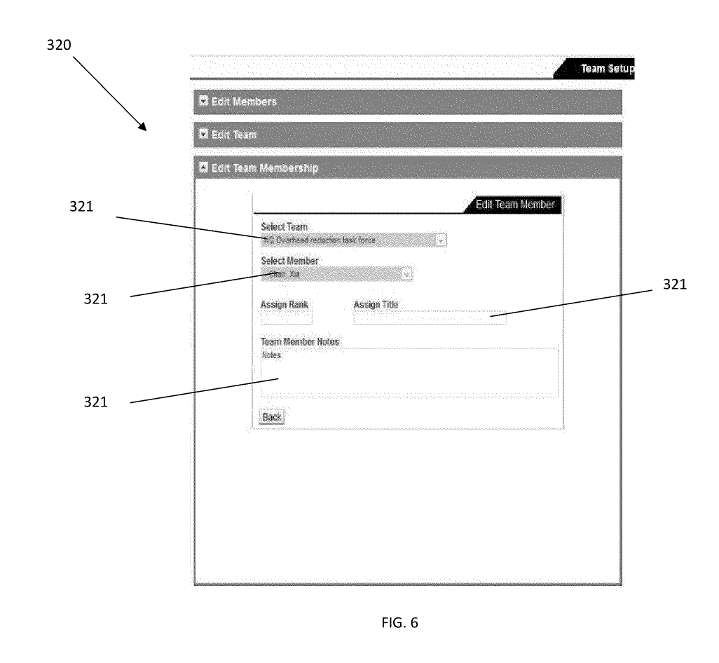

In one embodiment, as shown in FIG. 6, the user interface 110 can include a team window 320. The team window 320 can provide a collection of team elements 321 that give a user the tools needed to input, organize, query, browse, and/or view the content of a database 200. The team elements 321 can be drop-down menus, static menus, check boxes, buttons, tabs, input boxes, or the like for choosing or receiving the information to be displayed in the team window 320. The team elements 321 can have corresponding record fields in the database 200.

The team window 320 can receive and display team information associated with the users and/or administrators of the team (e.g. name, contact information, title, location, relationship to project, workstream, and/or initiative, or the like), and/or drop-down menus for choosing at least one project, workstream, initiative, or any combination thereof, to associate with the team. For example, the team window 320 can include a team drop-down menu, a member drop-down menu, title input box, and a notes input box.

In one embodiment, the user interface 110 can include a roadblock window (not shown). The roadblock window can provide a collection of roadblock elements that give a user the tools needed to input, organize, query, browse, and/or view the content of a database 200. The roadblock elements can be drop-down menus, static menus, check boxes, buttons, tabs, input boxes, or the like for choosing or receiving the information to be displayed in the roadblock window. The roadblock elements can have corresponding record fields in the database 200.

The roadblock window can receive and display roadblock information for assisting in over-coming obstacles that prevent successful project, workstream, initiative, stage, or phase completion (e.g. questions and answers pertaining to an obstacle). For example, the roadblock window can include a question input box and answer input box.

In some implementations, project management functionality can be included in an application using an Application Programming Interface (API) in place of the user interface 110. The API can allow a programmer to access project management methods according to call conventions defined by a project management API specification.

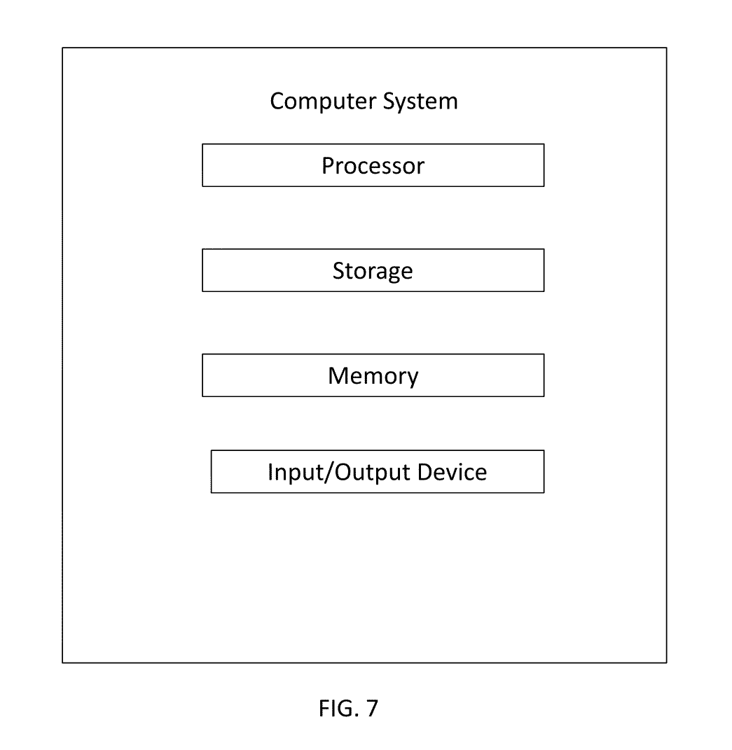

FIG. 7 is a schematic diagram of an example of a generic computer system. The system can be used for the operations described in association with the method according to one implementation. For example, the system may be included in either or all of a computer executing the database 200 application user interface, the method, or the database 200. The system can be included in a personal computer, mobile phone, email device, media player, electronic tablet, website server (in the cloud) or any other computing device.

In some implementations, the system can include a processor, memory, a storage device, and an input/output device. Each of the components are interconnected using a system bus. The processor is capable of processing instructions for execution within the system. The processor is capable of processing instructions stored in the memory or on the storage device to display graphical information for a user interface on the input/output device. In some implementations, the system can include multiple processors or processing cores.

The memory can store information within the system. In one implementation, the memory can be a computer-readable medium. In one implementation, the memory can be a volatile memory unit. In another implementation, the memory can be a non-volatile memory unit.

The storage device can be capable of providing mass storage for the system. In one implementation, the storage device can be a computer-readable medium. In various different implementations, the storage device can be a CD ROM, DVD, a hard disk device, an optical disk device, a tape device, micro disk, or thumb drive.

The input/output device provides input/output operations for the system. In one implementation, the input/output device can include a keyboard and/or pointing device such as a mouse or a trackball. In another implementation, the input/output device can include a display unit for displaying user interface.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

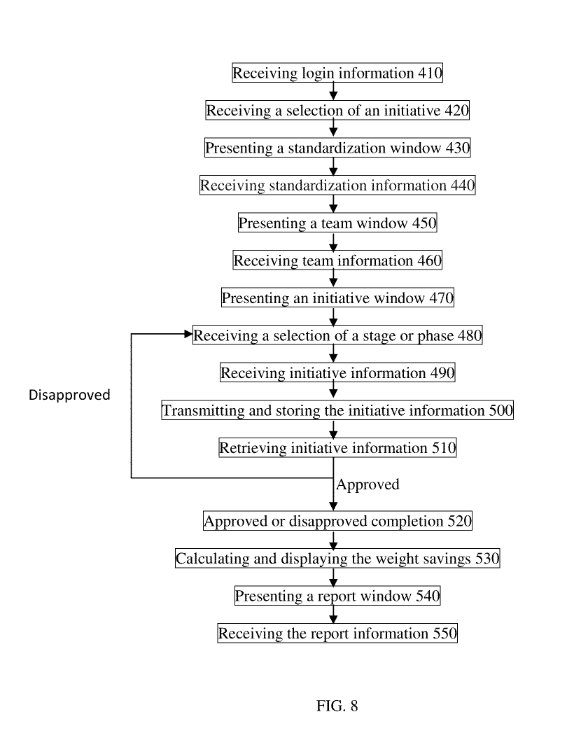

FIG. 8 is a flowchart of an exemplary method for managing a project by standardization. In one embodiment, as shown as block 410, the method has the step of receiving login information from a user. In one embodiment, the application receives the login information from a user. Login information can be any information associated with a user, for example, name, address, telephone number, email address, login name, password, or the like. The application presents input boxes to the user thereby prompting the user to provide the requested information. In one embodiment, the login information is obtained by allowing users to enter login information into an input box of a public web site, software application, or a mobile application. Once the login information is obtained, the login information is transmitted to a server and stored on the database 200, thereby allowing for the login information to be retrieved at a future date.

In one embodiment, as shown as block 420, the method may include receiving a selection of an initiative to manage. For example, the user might select an initiative by activating a user interface element from the user interface 110. For example, the user may activate user interface element within the user interface 110.

In one embodiment, as shown as block 430, the method may include presenting a standardization window having standardization items for receiving standardization information from the administrator. In one embodiment, the standardization window presented to the administrator is associated with the selected user interface element associated with initiative, thereby allowing for the received standardization information to be associated with the initiative selected. For example, user interface element was selected and user interface element is associated with initiative 42, thereby allowing for the received standardization information to be associated with initiative of user interface element.

In one embodiment, as shown as block 440, the method has the step of receiving standardization information for a project, workstream, initiative. In one embodiment, the standardization information is received from an administrator. Standardization information can be any information describing the organization of a project, workstream, initiative, or stage. For example, for the fan replacement initiative, the standardization information includes idea stage, written plan stage, approval stage, implementation stage, audit stage, and evaluation stage. The standardization information is transmitted and displayed as described with regard the transmittal and display of initiative information herein.

In one embodiment, as shown as block 450, the method may include presenting a team window 320 having team items for receiving team information from the user. In one embodiment, the team window 320 presented to an administrator is associated with the selected user interface element associated with initiative, thereby allowing for the received team information to be associated with the initiative selected. For example, user interface element was selected and user interface element is associated with a first team, thereby allowing for the received team information to be associated with initiative of user interface element.

In one embodiment, as shown as block 460, the method has the step of receiving team information. The team information can be received by a user entering the team information into a team item. For example, the user may, via the user interface element, input the team information associated with a first team into a team input box. The team information is then transmitted and displayed as described with regard the transmittal and display of initiative information herein.

In one embodiment, as shown as block 470, the method may include presenting an initiative window 130 having initiative items for receiving initiative information from the user. In one embodiment, the initiative window 130 presented to the user is associated with the selected user interface element associated with initiative, thereby allowing for the received initiative information to be associated with the initiative selected. For example, user interface element was selected and user interface element is associated with initiative 42, thereby allowing for the received initiative information to be associated with initiative of user interface element.

In one embodiment, as shown as block 480, the method may include receiving a selection of a stage or phase. For example, the user might select a phase or stage by activating an initiative item from the initiative window 130. For example, the user may activate a tab 143 within the initiative window 130 thereby selecting the phase associated thereto.

In one embodiment, as shown as block 490, the method may include receiving the initiative information. The initiative information can be received by a user entering the initiative information into an initiative item. For example, the user may, via the initiative window 130, input the initiative information associated with initiative 42 into stage information box 154.

In one embodiment, as shown as block 500, the method may include transmitting the initiative information to a server and storing the initiative information on a database 200, thereby allowing for the initiative information to be retrieved at a future date. For example, the application may send initiative information to database 200 as record 210.

In one embodiment, as shown as block 510, by way of the database 200, the initiative information stored as record 210 in the database 200 is retrieved and transmitted to the initiative window 130. For example, initiative information stored as record 210 is retrieved and transmitted to the initiative window 130.

In one embodiment, initiative descriptions, or information regarding the stages, phases, stage definitions 160, phase definitions, stage tabs 143, phase tabs 144, stage milestones, phase milestones, specific work activities of a stage or phase (i.e. the number of fans required for replacement), or the like displayed to the user by way of the initiative window 130, can be altered. In one embodiment, the initiative description is altered by an administrator, or a user authorized with access to alter initiative descriptions, create reports, or the like. For example, the administrator can alter the number and types of stages and phases represented by the initiative window 130 or the examples of the type of requested initiative information for the respective stage or phase. In one embodiment, a group or team of users can have administrator authorization.

In one embodiment, as shown as block 520, the stage or phase completion can be approved or disapproved by the administrator by selecting the approve/disapprove drop-down menu 180. Where the stage or phase is approved, the initiative enters the next stage or phase of the process and continues with blocks 490-520. When the stage or phase is disapproved, the initiative can be reverted back to the previous stage or phase, or can remain at the current stage or phase.

In one embodiment, as shown as block 530, the method may include calculating and displaying the weight savings, or the amount of the target budget savings attributed to an initiative as a component of a workstream or project. In one embodiment, the weight attributed to the initiative is calculated as the product of the percentage of stages and/or phases of the total number of stages and phases, and the target budget savings of the initiative. For example, where the first two of the stages have been completed, the initiative has been assigned a completion percentage of 33% and the target budget savings of the project is $100,000, the initiative weight is calculated to be 33% and the resulting weighted savings is calculated to be $33,000. In one embodiment, the weighted savings is displayed in the initiative window 130.

In one embodiment, as shown as block 540, the method may include presenting a report window 310 having report items for receiving report information from the administrator. In one embodiment, the report window 310 presented to the administrator is associated with the selected user interface element associated with initiative, thereby allowing for the report standardization information to be associated with the initiative selected. For example, user interface element was selected and user interface element is associated with initiative 42, thereby allowing for the received report information to be associated with initiative of user interface element.

In one embodiment, as shown as block 550, the method may include receiving the report information. The report information can be received by a user entering the report information into a report item. For example, the user may, via the initiative window 130, input the report information associated with initiative 42 into a drop-down menu of the report window. The report information is then transmitted and displayed as described with regard the transmittal and display of initiative information herein.

In one embodiment, the method has the step of receiving roadblock information. The roadblock information can be received by a user entering the roadblock information into a roadblock item. For example, the user may, via the roadblock element, input an answer to a question displayed by the roadblock window into a roadblock input box. The roadblock information is then transmitted and displayed as described with regard the transmittal and display of initiative information herein. In one embodiment, once the answer is transmitted, an additional question is displayed relating to the answer received and prompting an additional answer. In one embodiment, once the answer is transmitted, a suggestion is displayed relating to the answer received. In one embodiment, the roadblock information is displayed in the initiative window 130.

In one embodiment, the method has the step of creating and displaying a sub-initiative for overcoming the obstacle of a project, workstream, initiative, stage, or phase. In one embodiment, the sub-initiative is displayed in the initiative window 130.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A computer-implemented method, comprising:
presenting a user interface on a display device of a computer system, the user interface associated with a database,
presenting a standardization window,
receiving standardization information of a project, where the project is organized as a workstream, the workstream is organized as a plurality of initiatives, and the initiative is organized as a plurality of stages, where the stages are standardized allowing for each initiative to have the same stages,
presenting an initiative window on the user interface,
receiving initiative information, and
displaying initiative information in the initiative window,
where the method is performed by one or more processors.

2. The method of claim 1 wherein the stage is organized as a plurality of phases, where the phases are standardized allowing for each stage to have the same phases.

3. The method of claim 1, further comprising:
transmitting the initiative information to a server,
storing the initiative information on a database as a record,
retrieving the record from the database, and
displaying the initiative information to the initiative window.

4. The method of claim 1, further comprising altering initiative descriptions.

5. The method of claim 1, further comprising approving stage completion.

6. The method of claim 1, further comprising approving phase completion.

7. The method of claim 1, further comprising:
calculating the weight savings attributed to an initiative, and
displaying the weight savings in the initiative window.

8. The method of claim 1, further comprising:
presenting a report window,
receiving report information, and
displaying an initiative report in the initiative window.

9. The method of claim 1, further comprising:
receiving roadblock information, and
displaying roadblock information in the initiative window.

10. The method of claim 1, further comprising displaying a sub-initiative in the initiative window.

11. A computer-readable storage medium having instructions stored thereon, which when executed by a processor, causes the processor to perform operations comprising:
presenting a team window,
receiving team information, and
displaying an team information in the initiative window.

12. A computer-readable medium of claim 11, comprising:
presenting a user interface on a display device of a computer system, the user interface associated with a database,
presenting a standardization window
receiving standardization information of a project, where the project is organized as a workstream, the workstream is organized as a plurality of initiatives, and the initiative is organized as a plurality of stages, where the stages are standardized allowing for each initiative to have the same stages,
presenting an initiative window on the user interface,
receiving initiative information, and
displaying initiative information in the initiative window,
where the method is performed by one or more processors.

13. A computer-readable medium of claim 11 wherein the stage is organized as a plurality of phases, where the phases are standardized allowing for each stage to have the same phases.

14. A computer-readable medium of claim 11, further comprising:
transmitting the initiative information to a server,
storing the initiative information on a database as a record,
retrieving the record from the database, and
displaying the initiative information to the initiative window.

15. A computer-readable medium of claim 11, further comprising altering initiative descriptions.

16. A computer-readable medium of claim 11, further comprising approving stage completion.

17. A computer-readable medium of claim 11, further comprising approving phase completion.

18. A computer-readable medium of claim 11, further comprising:
calculating the weight savings attributed to an initiative, and
displaying the weight savings in the initiative window.

19. A computer-readable medium of claim 11, further comprising:
presenting a report window,
receiving report information, and
displaying an initiative report in the initiative window.

20. A computer-readable medium of claim 11, further comprising:
receiving roadblock information, and
displaying roadblock information in the initiative window.
